(19) United States
(12) Patent Application Publication
(10) Pub. No.: US 2026/0001514 A1
(43) Pub. Date: Jan. 1, 2026

(54) Control Method and Handle Assembly

(71) Applicant: Illinois Tool Works Inc., Glenview, IL (US)

(72) Inventor: Penghui Yi, Shanghai (CN)

(21) Appl. No.: 19/253,287

(22) Filed: Jun. 27, 2025

(30) Foreign Application Priority Data
Jun. 28, 2024 (CN) 202410856510.2

(51) Int. Cl. B60S 1/66; B60R 16/033; G07C 5/08; H05B 1/02

(52) U.S. Cl. CPC B60S 1/66; B60R 16/033; G07C 5/0816; H05B 1/0236; H05B 2214/02

(57) ABSTRACT

The present disclosure provides a method for removing ice from a vehicle's handle assembly using a selectable control system. The method includes receiving a control mode signal that selects one of several preset modes to carry out the de-icing operation. These control modes include at least two of the following: a monitoring mode, a vehicle standby mode, and a rapid de-icing mode. In the monitoring mode, the system continuously monitors the frozen state of the handle and applies heat at a first power level based on that condition. The vehicle standby mode preheats the handle at a second power level for a predetermined time before the vehicle is expected to be used. The rapid de-icing mode activates heating at a third power level when the vehicle is already in use. By allowing the selection of different modes based on driving habits or usage scenarios, the method enables a single control system to adapt to varying user needs and conditions.

### RELATED APPLICATION

The present application claims the benefit of Chinese Patent Application No. 202410856510.2, filed Jun. 28, 2024, each titled “Control Method and Handle Assembly,” the contents of which are hereby incorporated by reference.

### TECHNICAL FIELD

The present disclosure relates to the field of handle assemblies and control methods.

### BACKGROUND

In the prior art, a handle assembly is arranged on a vehicle sheet metal. A handle is rotatable relative to the vehicle sheet metal. However, in a relatively cool environment, the handle is prone to freezing, and ice may be removed by heating the handle.

### SUMMARY OF THE DISCLOSURE

The present disclosure relates generally to systema and a control method for performing an ice removal operation on a handle assembly of a vehicle, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a perspective view of a vehicle sheet metal for mounting a handle assembly according to the present disclosure.

FIG. 2 is a perspective view of a handle assembly according to the present disclosure.

FIG. 3 is an overview block diagram of a control flow of a handle assembly.

FIG. 4 is a control flow diagram of a handle assembly in a monitoring mode.

FIG. 5 is a control flow diagram of a handle assembly in a vehicle standby mode.

FIG. 6 is a control flow diagram of a handle assembly in a rapid deicing mode.

FIG. 7 is a block diagram of a control device of a handle assembly.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “processor” means processing devices, apparatuses, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general-purpose microprocessor or microcontroller, a digital signal processing (DSP) processor, an application-specific integrated circuit (ASIC). The processor may be coupled to or integrated with a memory device. The memory device can be any suitable type of computer memory or any other type of electronic storage medium, such as, for example, read-only memory (ROM), random access memory (RAM), cache memory, compact disc read-only memory (CD-ROM), electro-optical memory, magneto-optical memory, programmable read-only memory (PROM), erasable programmable read-only memory (EPROM), electrically erasable programmable read-only memory (EEPROM), a computer-readable medium, or the like.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

In some cold regions, a vehicle door handle is prone to freezing, which results in a user not being able to open a door. Ice on the handle may be melted through a heating operation to the handle by means of disposing a heating device on a door handle assembly or in a surrounding area thereof, thereby achieving the purpose of opening the door of the vehicle. However, in different regions, due to differences in factors such as ambient temperature and humidity, the frequency and extent of freezing on the vehicle handles vary. In addition, there are differences in the vehicle usage frequency and habits among different users. Even the same user may have different needs to use the vehicle in different vehicle usage situations.

For example, for a user of a commercial vehicle, the vehicle is used more frequently. In case of inclement weather (e.g., freezing rain), the handle is prone to freezing, so it is necessary to monitor the handle temperature and freezing conditions in real time, and provide real-time heating as needed to prevent the handle from being frozen, which may affect the use of the commercial vehicle at any time. For a user who has a regular need to use the vehicle (e.g., a user with regular working hours), it is desired that a vehicle handle be in its normal deployed state when the vehicle is used daily, so it is necessary to complete an ice removal operation within a predetermined period of time shortly before the vehicle is used, and the handle may not be re-frozen during the period of time between the completion of the ice removal operation and the use of the vehicle; and in the meantime, it is not desirable to complete the ice removal operation too early, as this may cause the vehicle handle to be re-frozen after the ice has melted, which results in unnecessary consumption of electric energy. In addition, the user needs to set in advance a specific time for using the vehicle, which places demands on the user's ability to plan ahead. For a user who does not have any plan for using the vehicle (e.g., a user who has a temporary need to use the vehicle), it is desirable to remove ice from the vehicle handle in the shortest possible time when the vehicle is in use, then an ice melting operation needs to be carried out through a higher heating power. The technical solution of the present disclosure takes into account the different needs, the different vehicle usage habits of users in different regions, or the different vehicle usage scenarios of the same customer. By setting up the same set of control system on the vehicle and adopting the same set of control method, it can satisfy the needs for vehicle usage of different users or in different scenarios, and independently select a control mode according to the user's needs, so as to carry out a corresponding heating operation for the vehicle handle.

According to the first aspect of the present disclosure, a control method for performing an ice removal operation on a handle assembly of a vehicle is provided, wherein the method comprises: S01, receiving a control mode signal, the control mode signal being a signal for selecting one control mode from preset control modes to perform the ice removal operation, wherein the control modes comprise at least two of a monitoring mode, a vehicle standby mode, and a rapid deicing mode, wherein the monitoring mode is configured to monitor a frozen state of the handle assembly in real time and heat the handle assembly at a first power according to the frozen state of the handle assembly, the vehicle standby mode is configured to preheat the handle assembly at a second power within a predetermined period of time before the vehicle is used, and the rapid deicing mode is configured to heat the handle assembly at a third power when the vehicle is in use; and S02, executing the control mode selected in step S01.

According to the first aspect of the present disclosure, step S02 comprises: S03-1, identifying a handle temperature and a battery level when the control mode is the monitoring mode.

According to the first aspect of the present disclosure, step S02 further comprises: S03-2, calculating a heating duration based on the identified handle temperature and the identified battery level if the identified handle temperature is lower than a preset temperature and the identified battery level is greater than a preset battery level; S03-3, heating the handle assembly at the first power for the heating duration; and S03-4, repeating step S03-2 and step S03-3.

According to the first aspect of the present disclosure, the preset temperature is 0 degree Celsius.

According to the first aspect of the present disclosure, step S02 further comprises: S03-5, sending a notification signal to a user if the identified battery level is not greater than a preset battery level.

According to the first aspect of the present disclosure, step S02 comprises: S04-1, receiving a vehicle using time signal set by a user, and calculating the duration from the current time to the time when the vehicle is used, when the control mode is the vehicle standby mode.

According to the first aspect of the present disclosure, step S02 further comprises: S04-2, heating the handle assembly at the second power for a preset heating duration if the calculated duration to the time when the vehicle is used is less than a preset duration and a handle is unable to be normally deployed; and S04-3, repeating step S04-2 until the handle is able to be normally deployed.

According to the first aspect of the present disclosure, step S02 comprises: S05-1, determining whether there is a trigger signal when the control mode is the rapid deicing mode.

According to the first aspect of the present disclosure, step S02 further comprises: S05-2, driving a handle to be deployed if the trigger signal is identified; S05-3, heating the handle assembly at the third power for a preset heating duration if the handle is not successfully deployed; and S05-4, driving the handle again to be deployed, and repeating step S05-3 until the handle is successfully deployed.

According to the first aspect of the present disclosure, the third power is greater than the second power, and the second power is greater than the first power.

According to the second aspect of the present disclosure, a handle assembly is provided, wherein the handle assembly is configured to perform an ice removal operation using the control method according to the first aspect of the present disclosure.

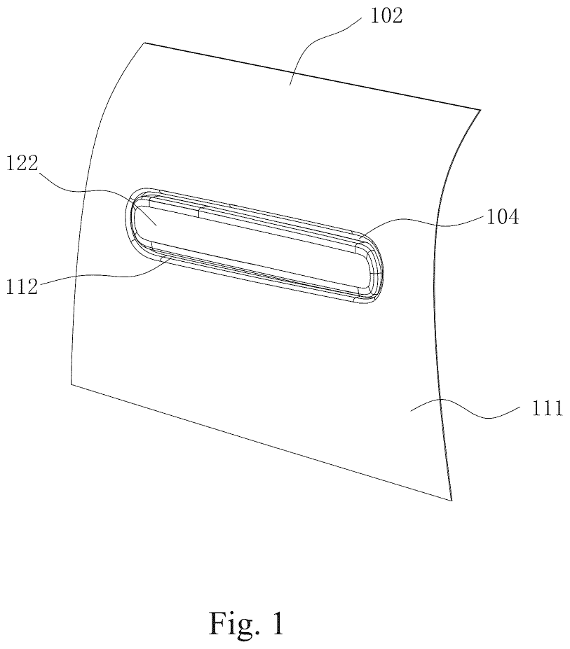

FIG. 1 is a perspective view of a vehicle sheet metal for mounting a handle assembly according to the present disclosure.

As shown in FIG. 1, a vehicle sheet metal 102 is provided with a mounting through hole 104, and a handle assembly 122 is mounted onto the vehicle sheet metal 102 from the inside of the vehicle sheet metal 102 partially through the mounting through hole 104. The mounting through hole 104 runs through the vehicle sheet metal 102 in a thickness direction (i.e., a first direction) of the vehicle sheet metal 102. A perimeter surrounding the mounting through hole 104 has a flanged edge for mounting the handle assembly. Specifically, the vehicle sheet metal 102 includes a first sheet metal face 111 and a second sheet metal face 112 connected to each other. The first sheet metal face 111 is formed by extending in a direction substantially perpendicular to the first direction. The second sheet metal face 112 is substantially perpendicular to the first sheet metal face 111. In other words, the second sheet metal face 112 is formed by extending from the first sheet metal face 111 toward one side. The handle assembly 122 is moved on an inner side of the vehicle sheet metal 102 in the first direction to be mounted onto the vehicle sheet metal 102. There is a chamfer at a junction of the first sheet metal face 111 and the second sheet metal face 112, and the second sheet metal face 112 is thus in the shape of a circular arc.

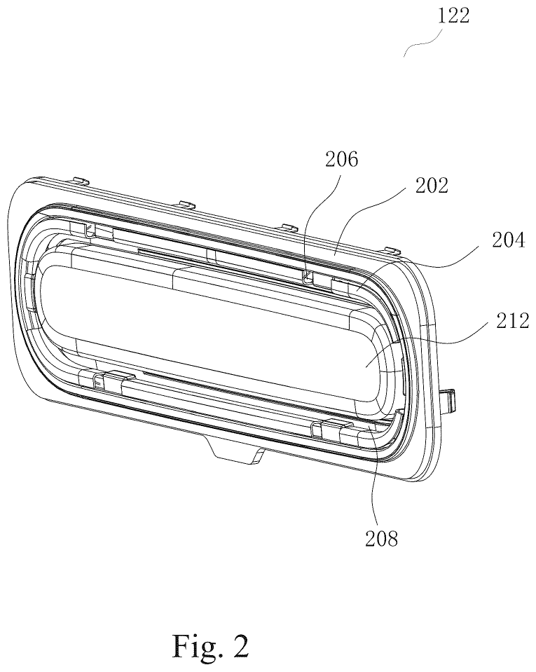

FIG. 2 is a perspective view of a handle assembly according to the present disclosure.

As shown in FIG. 2, a handle assembly 122 includes a base 202, a plurality of heating elements 204 (e.g., six), and a plurality of connecting devices 206. The base 202 is provided with a base through hole 208 running through the base 202 in the first direction. The plurality of heating elements 204 are disposed around the base through hole 208, and each of the heating elements 204 is disposed around a part of the base through hole 208. The plurality of connecting devices 206 are arranged between the base 202 and the plurality of heating elements 204, and connect the base 202 and the plurality of heating elements 204. In order to fit better with the first sheet metal face 111 and the second sheet metal face 112, each of the plurality of heating elements 204 has a chamfer, and is thus in the shape of a circular arc. However, in other embodiments, the heating element 204 may have no chamfer. The connecting device 206 is flexible, and accordingly the connecting device 206 is deformable. The connecting device 206 is configured to enable the heating element 204 to move relative to the base 202. Specifically, the connecting device 206 is made of a flexible material. In an example, the flexible material refers to TPE. In an example, the connecting device 206 is connected to the base 202 by injection molding. The handle assembly 122 further includes a handle 212. At least a part of the handle 212 is disposed in the base through hole 208 and is movable relative to the base 202. The handle 212 is configured to enable the unlocking of a vehicle door. A handle driving device (not shown) is further disposed inside the handle assembly 122 to drive the deployment and retraction of the handle 212.

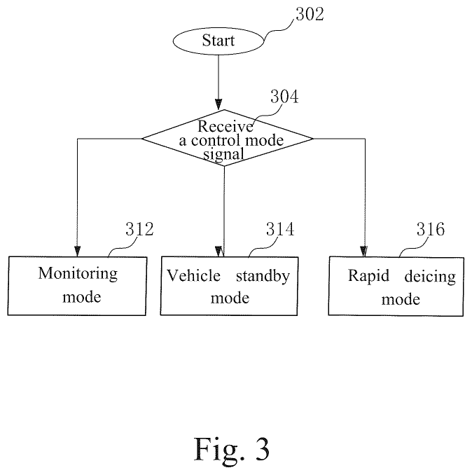

FIG. 3 is an overview block diagram of a control flow for a handle assembly.

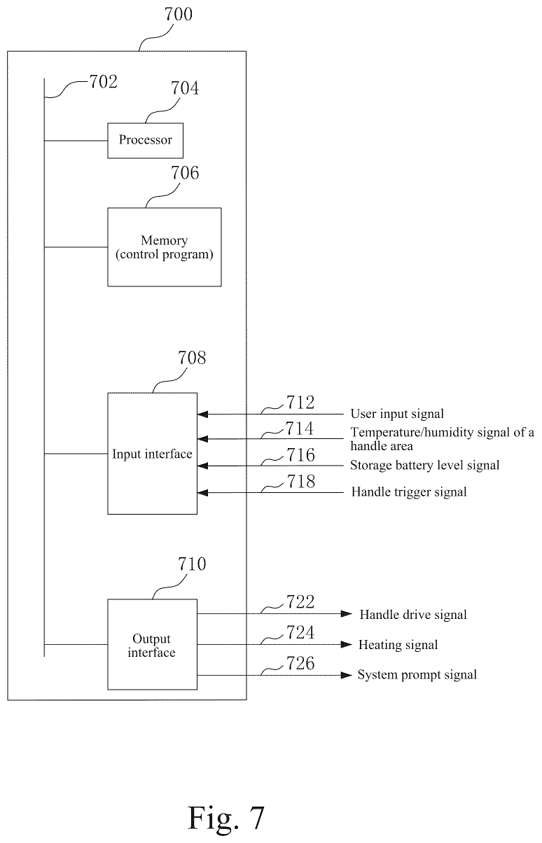

As shown in FIG. 3, when a vehicle is in a relatively cool environment, a handle is prone to freezing. In different vehicle usage scenarios, a user may select different control modes for handle heating according to the needs, patterns or habits in using the vehicle over a period of time, so as to accomplish an ice removal operation on the vehicle handle. The vehicle is provided with a control system inside which is in wireless communication (e.g., connection via the Internet) with a remote terminal of the user (e.g., a user mobile App and a remote control panel) to receive signals input by the user, such as signals for selection of the heating control mode, setting of the vehicle usage time, and exiting the heating mode. A temperature sensor and a humidity sensor respectively configured to monitor the temperature and humidity of a handle area are disposed near the vehicle handle, which can identify the temperature and humidity of the handle area and feed back the identified temperature and humidity to the control system. A button or a detector (such as an infrared or light spot sensor) configured to trigger and control the deployment of the handle is disposed near the vehicle handle, which may transmit a handle trigger signal to the control system after receiving the signal to perform a handle deploying operation. The control system is further communicatively connected to a storage battery, so as to obtain the real-time battery level of the storage battery. The control system is further provided with a module or control device 700 (as shown in FIG. 7) that controls the heating of the handle, the driving of the handle (deployment and retraction), and some other functions, and the movement of the handle may be driven based on the above feedback information received by the control system.

In step 302, a handle heating control system is started, and then the flow proceeds to step 304 of receiving a control mode signal. A handle control system of the vehicle is communicatively connected to a remote user control terminal, a user may select different control modes according to the future needs for vehicle usage on an interactive interface of the control terminal to obtain an optimal user experience, and the control system may receive a corresponding control signal based on the control mode selected by the user. If the control system receives that the user selects a monitoring mode, then the flow proceeds to step 312; if the control system receives that the user selects a vehicle standby mode, then the flow proceeds to step 314; and if the control system receives that the user selects a rapid deicing mode, then the flow proceeds to step 316. For those of at least ordinary skill in the art, in some other embodiments, the control system for heating the handle may include only any two of the above three control modes (the monitoring mode, the vehicle standby mode, and the rapid deicing mode), and the user may select the corresponding control mode to heat the handle according to needs.

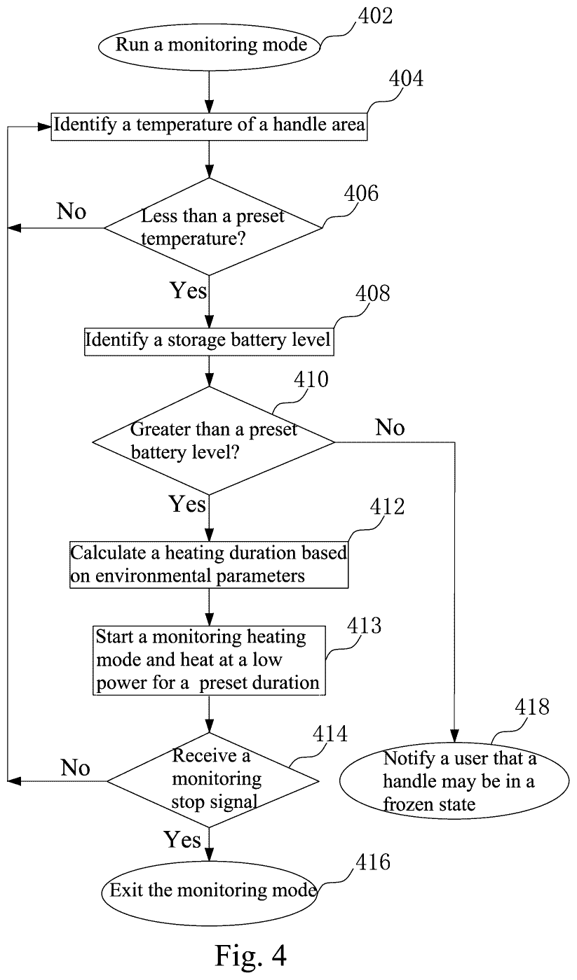

FIGS. 4 to 6 below describe the specific control flows in the monitoring mode, the vehicle standby mode and the rapid deicing mode, respectively.

FIG. 4 is a control flow diagram of a handle assembly in a monitoring mode. In the monitoring mode, the control system monitors a frozen state of the vehicle handle in real time, and starts the heating device to heat the handle and a surrounding area with a lower power once the vehicle handle is in an impending or just frozen state, ensuring that the vehicle handle remains in a normal use state without freezing. Since the state of the vehicle handle needs to be continuously monitored in the monitoring mode, there are certain requirements for a battery level of the storage battery. Based on the ambient temperature and the storage battery level, the available heating duration at a low power is calculated, and the user is informed of the information related to the state of the handle in the case of an insufficient battery level.

As shown in FIG. 4, in step 402, the control flow runs in a monitoring mode based on the user's choice in step 304 above, and then the flow proceeds to step 404 of identifying the temperature of the handle area. After the operation of step 404 is completed, the flow proceeds to step 406. In step 406, it is determined whether the temperature of the handle area is less than a preset temperature, for example, 0° C. or 30° C. If the temperature of the handle area is less than the preset temperature, i.e., the handle may be frozen at any time or the handle temperature is low, then the flow proceeds to step 408. If the temperature of the handle area is not less than the preset temperature, i.e., the possibility of the handle being frozen is low or the handle remains at a warm grip temperature, then the flow returns to step 404 to continuously monitor the temperature of the handle area. In step 408, a storage battery level is identified. After the operation of step 408 is completed, the flow proceeds to step 410. In step 410, it is determined whether the storage battery level is greater than a preset battery level, for example, 10%. If the storage battery level is greater than the preset battery level, it indicates that the storage battery level is adequate which is sufficient to support the control system to monitor the handle state for a long time, then the flow proceeds to step 412; and if the storage battery level is not greater than the preset battery level, it indicates that the storage battery level is inadequate which may be insufficient to support the control system to monitor the handle state for a long time, then the flow proceeds to step 418. In step 418, the user is notified that the handle may be in a frozen state and the storage battery level is low, then the user may make a judgement on his or her own whether it is necessary to change the control mode or perform a charging operation on the vehicle based on the current environmental conditions or the needs for vehicle usage. In step 412, a heating duration is calculated based on environmental parameters (e.g., an ambient temperature and a humidity). The heating duration may be calculated, for example, on the basis of Table 1 as follows:

TABLE 1

Temperature

| | | | |
|---|---|---|---|
| −10° C. | −20° C. | −30° C. | . . . |

| | |
|---|---|
| Humidity | Heating duration |

| | | | | |
|---|---|---|---|---|
| 100% | 5 min | 8 min | 10 min | . . . |
| 90% | 3 min | 5 min | 8 min | . . . |
| 80% | 1 min | 3 min | 5 min | . . . |
| . . . | . . . | . . . | . . . | . . . |

After the operation of step 412 is completed, the flow proceeds to step 413. In step 413, a monitoring heating mode is started to heat the handle at a low power (e.g., not greater than 10 W) for a preset duration of time. After the operation of step 413 is completed, the flow proceeds to step 414. In step 414, it is determined whether a monitoring stop signal input by the user at a remote terminal is received. If the monitoring stop signal input by the user at the remote terminal is received, it indicates that the user does not intend to continue to monitor the frozen state of the handle of the vehicle in real time, and then the flow proceeds to step 416 of exiting the monitoring mode. If the monitoring stop signal input by the user at the remote terminal is not received, it indicates that the user does not intend to terminate the real-time monitoring of the frozen state of the vehicle handle, then the flow returns to step 404, and the above operations are repeated to continue to carry out the real-time monitoring on the frozen state of the vehicle handle.

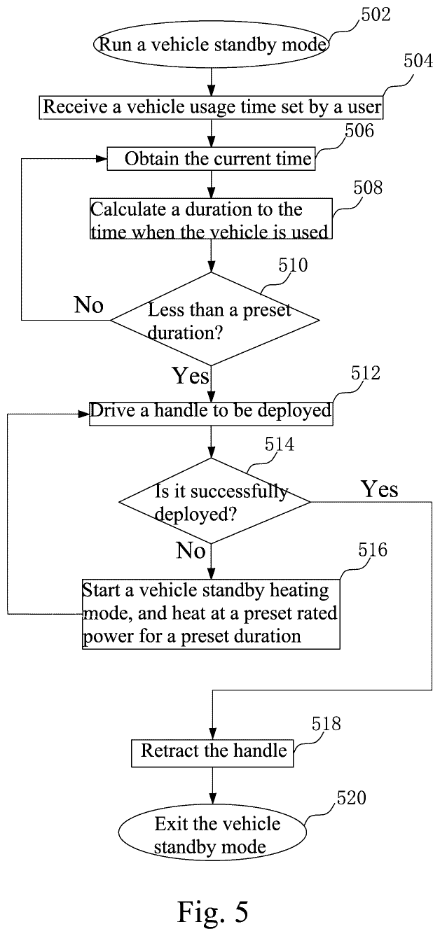

FIG. 5 is a control flow diagram of a handle assembly in a vehicle standby mode. In the vehicle standby mode, the vehicle handle is heated in advance at a medium power for a predetermined period of time before the vehicle is used, ensuring that the user completes an ice removal operation on the handle in a period of time shortly before the vehicle is used. In the vehicle standby mode, it is necessary to preset a vehicle usage time for the user, thereby imposing certain requirements on a vehicle usage plan of the user. The user needs to know the exact time of the next use of the vehicle to set the vehicle usage time, so that the control system may complete the possible ice removal operation on the handle of the vehicle in a period of time shortly before the vehicle is used, ensuring that the handle has been in normal use state at the vehicle usage time set by the user.

As shown in FIG. 5, in step 502, the control flow runs in a vehicle standby mode based on the user's choice in step 304 above, and then the flow proceeds to step 504. In step 504, a vehicle usage time signal set by the user is received, for example, 8:00 am on weekdays. After the step 504 is completed, the flow proceeds to step 506. In step 506, the current time is obtained. After the step 506 is completed, the flow proceeds to step 508. In step 508, the control system calculates a duration from the current time to the vehicle usage time preset by the user based on the vehicle usage time preset by the user in step 504 and the current time obtained in step 506. After the step 508 is completed, the flow proceeds to step 510. In step 510, it is determined whether the duration from the current time to the vehicle usage time preset by the user is less than a preset duration stored by the system, for example, 15 minutes. If it is less than the preset duration, it indicates that the current time is near the vehicle usage time of the user, so the handle state needs to be identified to ensure the proper use of the handle, and then the flow proceeds to step 512. If it is not less than the preset duration, it indicates that the current time is too early relative to the vehicle usage time of the user and there is no need to identify the handle state too early, then the flow returns to step 506, and the above steps are repeated until the current time is close to the vehicle usage time of the user. In step 512, a control device of the control system drives the handle to be deployed, ensuring that the vehicle handle is in a normal use state. After the step 512 is completed, the flow proceeds to step 514. In step 514, it is determined whether the vehicle handle can be successfully deployed. If the vehicle handle can be successfully deployed, i.e., the vehicle handle is not frozen, the flow proceeds to step 518; and if the vehicle handle cannot be successfully deployed, i.e., the vehicle handle has been frozen, the flow proceeds to step 516. In step 516, a vehicle standby heating mode is started to heat the handle at a medium rated power (e.g., 20 W) for a preset duration, e.g., 30 seconds. After the step 516 is completed, the flow returns to step 512, and the above steps are repeated until the vehicle handle can be successfully deployed. In step 518, the control device of the control system sends a handle retraction instruction to drive the handle to be retracted. After the step 518 is completed, the flow proceeds to step 520 of exiting the vehicle standby mode to wait for the user to use the vehicle.

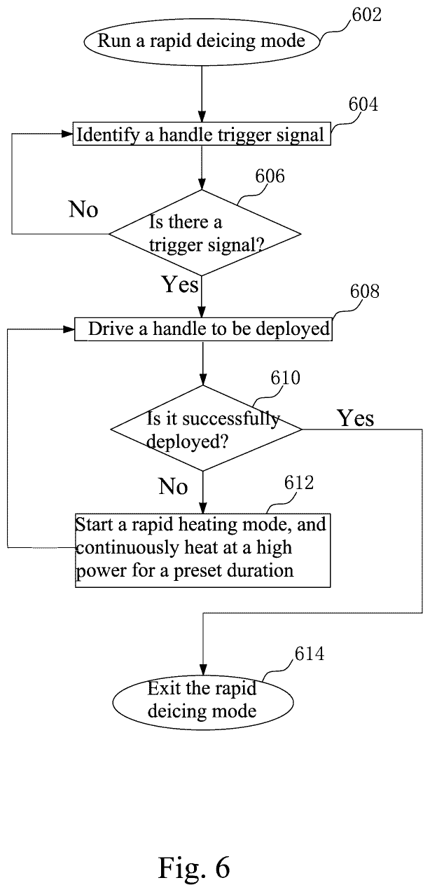

FIG. 6 is a control flow diagram of a handle assembly in a rapid deicing mode. In the rapid deicing mode, the vehicle handle may be heated at a high power according to the user's real-time needs for vehicle usage to achieve the purpose of a quick ice removal, which is suitable for scenarios in which a user does not set the time to use the vehicle in advance or a user has a temporary need to use the vehicle.

As shown in FIG. 6, in step 602, the control flow runs in a rapid deicing mode based on the user's choice in step 304 above, and then the flow proceeds to step 604 of identifying a handle trigger signal. After the step 604 is completed, the flow proceeds to step 606 of determining whether there is a trigger signal. If the trigger signal is identified, it indicates that the user has pressed the button controlling the deployment of the handle or has touched the detector, then the flow proceeds to step 608; and if no trigger signal is identified, it indicates that the user has not yet pressed the button controlling the deployment of the handle or has not touched the detector, then the flow returns to step 604, repeating the above steps. In step 608, the control system sends a handle deployment signal to the handle driving device to drive the handle to be deployed. After the step 608 is completed, the flow proceeds to step 610. In step 610, if the handle is successfully deployed, it indicates that the handle has not been iced or frozen, the user may directly perform a door opening operation, and then the flow proceeds to step 614 of exiting the rapid deicing mode; and if the handle is not successfully deployed, it indicates that the handle has been iced or frozen, then the flow proceeds to step 612. In step 612, a rapid heating mode is started to heat the handle at a high power (e.g., not less than 40 W) for a preset duration, e.g., 10 seconds. After the step 612 is completed, the flow returns to step 608 to drive the handle to be deployed again until the handle is successfully deployed.

FIG. 7 is a block diagram of a control device of a handle assembly.

As shown in FIG. 7, the control device 700 includes a bus 702, a processor 704, a memory 706, an input interface 708, and an output interface 710. The processor 704, the memory 706, the input interface 708 and the output interface 710 are connected to the bus 702. The processor 704 can read a program (or an instruction) from the memory 706, and execute the program (or the instruction) to process data; and the processor 704 can further write data or the program (or the instruction) into the memory 706. The memory 706 can store the program (the instruction) or the data. By executing the instruction in the memory 706, the processor 704 may control the memory 706, the input interface 708 and the output interface 710. In the present disclosure, the memory 706 is capable of executing control programs of the flows shown in FIGS. 3 to 6 and storing operating parameters required for executing the programs (e.g., the vehicle usage time set by the user, the heating duration at various heating powers, and the preset duration from the vehicle usage time).

The input interface 708 is configured to acquire user input signals (e.g., signals of the heating control mode, vehicle usage time and exiting the heating mode that are input by the user), temperature and humidity signals of the handle area, a storage battery signal, and a handle trigger signal, respectively, via connection lines 712, 714, 716 and 718, and to convert data of these signals into signals recognizable by the processor 704 and store them in the memory 706.

The processor 704 is configured to execute the programs stored in the memory 706 on the basis of the above acquired signals, generate a handle driving device control signal, a handle heating device control signal or a system prompt signal on the basis of instructions of the control programs, and send the above generated signals to the output interface 710. The output interface 710 is configured to receive the handle driving device control signal from the processor 704 and transmit the handle driving device control signal to the handle driving device via a connection line 722 to drive the deployment and retraction of the handle. The output interface 710 is further configured to receive the handle heating device control signal from the processor 704 and transmit the handle heating device control signal to a handle heating device via a connection line 724 to control the heating of the handle and the surrounding area. The output interface 710 is configured to receive the system prompt signal from the processor 704 and transmit the system prompt signal to a user interaction terminal via a connection line 726 to prompt or inform the user that the handle may currently be in a frozen state and/or that the storage battery level is low, thereby instructing the user to perform the corresponding operations, for example, the user may make a judgement whether the control mode needs to be changed or to perform a charging operation for the vehicle according to the current environmental conditions or the needs for vehicle usage.

According to the present disclosure, the control method for performing an ice removal operation on a vehicle handle may have at least the following beneficial technical effects:

The technical solution of the present disclosure takes into account different vehicle usage habits of different users, or different vehicle usage scenarios of the same customer, and satisfies the needs for vehicle usage of different users or in different scenarios by setting up the same set of control system on the vehicle. The handle control system of the vehicle is communicatively connected to a remote control terminal, and the user may select different control modes and carry out corresponding vehicle handle heating operations according to future or current needs for vehicle usage on an interactive interface of the remote control terminal, so as to achieve the optimal user experience.

Although the present disclosure is described with reference to the examples of the embodiments outlined above, various alternatives, modifications, variations, improvements and/or substantial equivalents, which are known or can be anticipated at present or to be anticipated before long, may be obvious to those of at least ordinary skill in the art. In addition, the technical effects and/or technical problems described in this specification are exemplary rather than limiting; therefore, the disclosure in this specification may be used to solve other technical problems and may have other technical effects. Accordingly, the exemplary embodiments of the present disclosure set forth above are illustrative in nature and not meant to be limiting. Therefore, various changes may be made without departing from the spirit or scope of the present disclosure. Therefore, the present disclosure is intended to encompass all known or earlier disclosed alternatives, modifications, variations, improvements, and/or substantial equivalents.

What is claimed is:

1. A control method for performing an ice removal operation on a handle assembly of a vehicle, the method comprising:
S01, receiving a control mode signal, the control mode signal being a signal for selecting one control mode from preset control modes to perform the ice removal operation, wherein the control modes comprise at least two of a monitoring mode, a vehicle standby mode, and a rapid deicing mode, wherein the monitoring mode is configured to monitor a frozen state of the handle assembly in real time and heat the handle assembly at a first power according to the frozen state of the handle assembly, the vehicle standby mode is configured to preheat the handle assembly at a second power within a predetermined period of time before the vehicle is used, and the rapid deicing mode is configured to heat the handle assembly at a third power when the vehicle is in use; and
S02, executing the control mode selected in step S01.

2. The control method of claim 1, wherein step S02 comprises:
S03-1, identifying a handle temperature and a battery level when the control mode is the monitoring mode.

3. The control method of claim 2, wherein step S02 further comprises:
S03-2, calculating a heating duration based on the identified handle temperature and the identified battery level if the identified handle temperature is lower than a preset temperature and the identified battery level is greater than a preset battery level;
S03-3, heating the handle assembly at the first power for the heating duration; and
S03-4, repeating step S03-2 and step S03-3.

4. The control method of claim 3, wherein the preset temperature is 0 degree Celsius.

5. The control method of claim 2, wherein step S02 further comprises:
S03-5, sending a notification signal to a user if the identified battery level is not greater than a preset battery level.

6. The control method of claim 1, wherein step S02 comprises:
S04-1, receiving a vehicle usage time signal set by a user, and calculating the duration from the current time to the time when the vehicle is used, when the control mode is the vehicle standby mode.

7. The control method of claim 6, wherein step S02 further comprises:
S04-2, heating the handle assembly at the second power for a preset heating duration if the calculated duration to the time when the vehicle is used is less than a preset duration and a handle is unable to be normally deployed; and
S04-3, repeating step S04-2 until the handle is able to be normally deployed.

8. The control method of claim 1, wherein step S02 comprises:
S05-1, determining whether there is a trigger signal when the control mode is the rapid deicing mode.

9. The control method of claim 8, wherein step S02 further comprises:
S05-2, driving a handle to be deployed if the trigger signal is identified;
S05-3, heating the handle assembly at the third power for a preset heating duration if the handle is not successfully deployed; and
S05-4, driving the handle again to be deployed, and repeating step S05-3 until the handle is successfully deployed.

10. The control method of claim 1, wherein the third power is greater than the second power, and the second power is greater than the first power.

11. A handle assembly, wherein the handle assembly is configured to perform an ice removal operation using the control method according to claim 1.
